(19) United States
(12) Patent Application Publication
(10) Pub. No.: US 2008/0183981 A1
(43) Pub. Date: Jul. 31, 2008

(54) ELECTRONIC ENDOSCOPE

(75) Inventor: Katsuya TANNAI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/876,952

(22) Filed: Oct. 23, 2007

(30) Foreign Application Priority Data
Oct. 24, 2006 (JP) 2006-288235

(51) Int. Cl. G06F 12/00

(52) U.S. Cl. 711/154; 711/E12.001

(57) ABSTRACT

An electronic endoscope has a programmable logic device (PLD), a memory, and a program setting controller. The PLD creates a signal-processing circuit, based on a program data set associated with a signal process. The memory stores at least two program data sets such as configuration data sets, each having the same data content. The program setting controller reads a given program data set from the memory, and then writes the read program data set onto the logic device. Further, the program setting controller determines whether the read program data set is intact. Then, if the read program data set is not intact, the program setting controller writes another program data set, stored in the memory, onto the PLD.

### BACKGROUND OF THE INVENTION

1. Field of the Invention

The present invention relates to an electronic endoscope equipped with a video-scope having an image sensor. In particular, it relates to a programming process using a programmable logic device.

2. Description of the Related Art

In the video-scope of an electronic endoscope, a signal-processing circuit is provided to process image-pixel signals read from an image sensor. A PLD (Programmable Logic Device) such as an FPGA (Field Programmable Gate Array) is incorporated into a circuit board to constitute a signal-processing circuit suitable for the connected video-scope and image sensor. Also, a PLD can be used to enable new signal processing-functions. A set of program data such as configuration data which is part of the design of the signal-processing circuit, is written in the PLD, and the PLD carries out a signal process based on this written program data.

However, when connecting a video-scope with a video processor, all or part of the configuration data is occasionally erased due to excessive electric current. Consequently, a bug occurs in the program data and a defective signal-processing circuit is created.

### SUMMARY OF THE INVENTION

An object of the present invention is to provide an electronic endoscope that is capable of always creates or constructing a signal-processing circuit based on intact program data.

An electronic endoscope according to the present invention has a programmable logic device (PLD), a memory, and a program setting controller. The programmable logic device creates a signal-processing circuit based on a program data set associated with a signal process. The memory stores at least two program data sets, such as configuration data sets, each having the same data content. The program setting controller reads a given program data set from the memory, and then writes the read program data set onto the logic device. As an example, the programmable logic device may be provided in a video-scope, together with memory.

In the present invention, the program setting controller determines whether the read program data set is intact. If the read program data set is not intact (i.e., it is corrupt), the program setting controller writes another program data set, stored in the memory, onto the logic device. Thus, the erroneous program data set is not used, and a signal-processing circuit is created based on an intact program data set.

Since another program data set in memory may also have bugs, preferably, the program setting controller determines whether another program data set is intact, and writes another program data set onto the logic device if it is determined to be intact.

In order to correct a abnormal program data set determined to be corrupt, the program setting controller may correct the corrupt program data set on the basis of another intact program data set stored in the memory. For example, the program setting controller may replace the corrupt program data set with a different, intact program data set in the memory.

In order to always keep a spare program data set intact, preferably, it is checked for corruption against the program data stored in the memory. The program setting controller may determine whether a given unused program data set, stored in the memory is, intact. If it is corrupt, the program setting controller may correct the corrupt program data set on the basis of the program data set written in the PLD.

When the logic device and the memory are provided in a video-scope, the program setting controller may write the program data set when the video-scope is connected to a video-processor.

An apparatus for creating a signal-processing circuit for an electronic endoscope, according to another aspect of the present invention, has a determiner that determines whether a program data set in memory, associated with a signal process, is normal; and a program setting controller that writes the program data set onto a PLD (programmable logic device) when the program data set is intact, and writes another program data set having the correct original data content, stored in the memory, onto the logic device when the read program data set is not intact.

A computer-readable medium that stores a program for creating a signal-processing circuit of an electronic endoscope, according to another aspect of the present invention, has a determination code segment that determines whether a program data set in memory, associated with a signal process, is intact; and a program-setting-control code segment that writes the program data set onto a programmable logic device when the program data set is intact, and writes another program data set having the correct original data content, stored in the memory, onto the logic device when the read program data set is corrupt.

A method for creating a signal-processing circuit of an electronic endoscope, according to another aspect of the present invention, includes: a) determining whether a program data set in a memory, associated with a signal process, is intact; b)writing the program data set onto a programmable logic device when the program data set is intact; and c) writing another program data set having the correct original data content, stored in the memory, onto the logic device when the read program data set is not normal.

### BRIEF DESCRIPTION OF THE DRAWINGS

The present invention will be better understood from the description of the preferred embodiments of the invention set forth below together with the accompanying drawings, in which:

FIG. 1 is a block diagram of an electronic endoscope according to a present embodiment; and

FIG. 2 is a flowchart of a configuration-data setting process performed by the scope controller.

### DESCRIPTION OF THE PREFERRED EMBODIMENTS

Hereinafter, the preferred embodiment of the present invention is described with reference to the attached drawings.

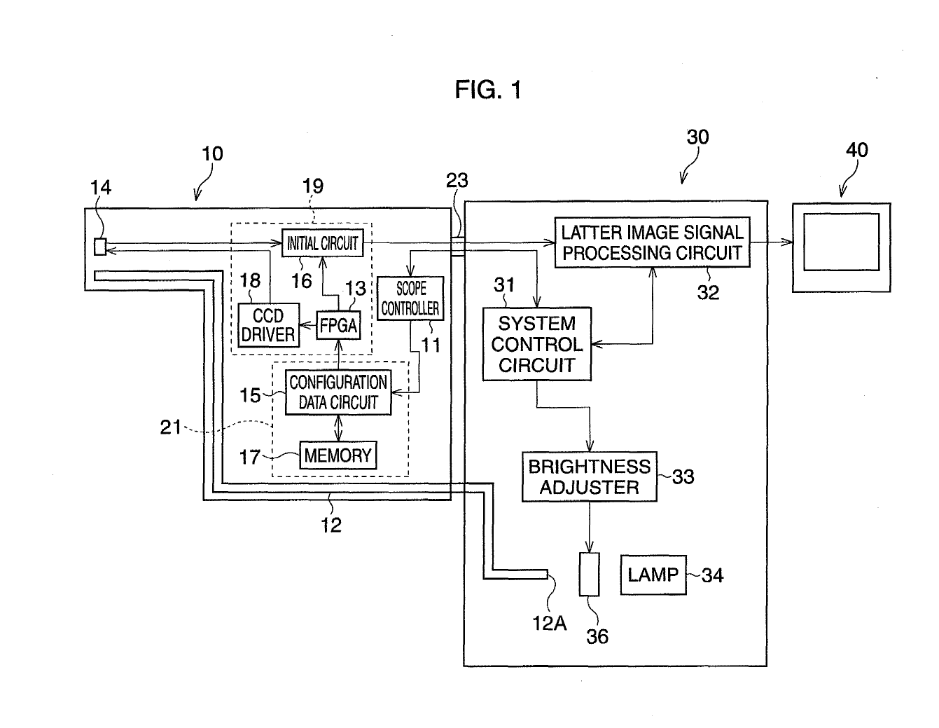

FIG. 1 is a block diagram of an electronic endoscope according to a present embodiment.

The electronic endoscope is equipped with a video-scope 10 with a CCD 14, and a video-processor 30. The video-scope 10 is removably connected to the video-processor 30, and a monitor 40 is connected to the video-processor 30. When the video-scope 10 is connected to the video-processor 30, electric power is supplied by the video-processor 30 to the video-scope 10. Thus, the video-scope 10 is turned on.

When a lamp switch button (not shown) is turned on, a lamp 34 emits illuminating light. The illuminating light emitted from the lamp 34 enters the incident surface 12A of a light guide 12 via a diaphragm 36 and a collecting lens (not shown). The light-guide 12, constructed of a fiber-optic bundle, directs the illuminating light to the distal end of the video-scope 10. The light exits the distal end surface of the light-guide 12, and radiates onto an observed object via a diffusion lens (not shown).

Light, reflected off the object, reaches the CCD 14 via an objective lens (not shown) , so that an object image is formed on the photo sensitive area of the CCD 14, and analog image-pixel signals are generated. The generated image-pixel signals are read from the CCD 14 at regular time intervals, and output to an initial circuit 16 in an image signal-processing circuit 19. The CCD driver 18 in the image signal-processing circuit 19 drives the CCD 14 in accordance with the NTSC (or PAL) video standard; therefore, the image-pixel signals are read from the CCD 14 at 1/60- (or 1/50-) second intervals. In the initial circuit 16, the image-pixel signals are amplified and converted to digital image signals. The digital image signals are output to a latter image signal-processing circuit 32 in the video-processor 30.

In the latter image signal-processing circuit 32, various processes, such as white balance adjustment, gamma-correction, are carried out on the image signals in order to generate video signals according to the NTSC/PAL video standard are generated. The generated video-signals are output to the monitor 40. Thus, an observed image is displayed on the monitor 60. Also, luminance signals are generated in the latter image signal-processing circuit 32 and output to a system control circuit 31.

The system control circuit 31, including a CPU, a RAM unit, and a ROM unit (not shown), controls the video processor 30 by outputting control signals to other circuits. The diaphragm 36 opens and closes to adjust the amount of illuminating light, and is driven by a motor (not shown). The brightness adjuster 33 controls the diaphragm 36 on the basis of the detected luminance level, so as to maintain the brightness of an object image displayed on the monitor 60 at the proper brightness.

A scope controller 11, including CPU, ROM, and RAM (not shown), controls the video-scope 10. A program for controlling the video-scope 10 and setting the program data is stored in the ROM. When the video-scope 10 is connected to the video-processor 30, the system control circuit 31 detects the connection of the video-scope 10 via a pin 23. Then, data is communicated between the video-scope 10 and the video-processor 30.

An FPGA (Field Programmable Gate Array) 13 creates the signal-processing circuit 19 on the basis of a set of configuration data. The set of configuration data is a data set that defines functions of the signal-processing circuit 19. The signal-processing circuit 19 operates in accordance with the set of configuration data. The initial circuit 16 and the CCD driver 18 in the signal-processing circuit 19 carry out operations set by the FPGA 13.

In the memory 17 (such as a ROM unit), a plurality of configuration data sets is stored. Herein, a main configuration data set and a spare configuration data set, which have the same data contents, are stored in the memory 17. Either the main or spare configuration data set is written onto a configuration data circuit 15. Then, as described below, the contents of the configuration data set are checked and subsequently the main or spare configuration data set is written to the FPGA 13.

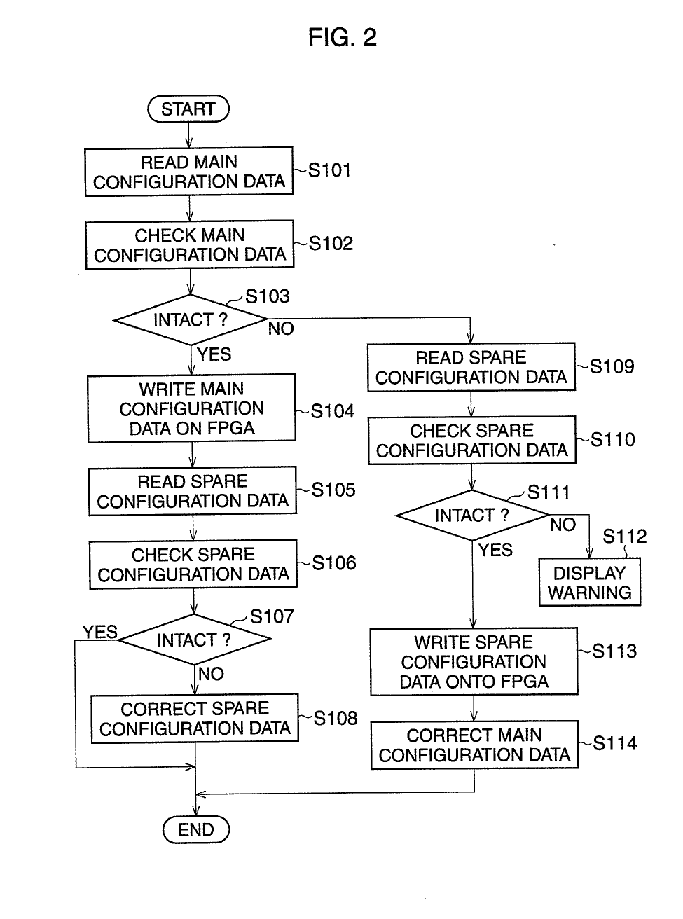

FIG. 2 is a flowchart of a configuration-data setting process performed by the scope controller 11. The process begins when the video-scope 10 is connected to the video-processor 30.

In Step S101, the main set of configuration data is read from the memory 17 by the scope controller 11, and fed to the configuration data circuit 15. In Step S102, the checksum of the configuration data is calculated in order to determine whether the main configuration data set is intact or normal.

In Step S103, it is determined whether the checksum of the configuration data coincides with a target value that should be obtained if the main configuration data is intact. If the checksum test fails, the main configuration data has been altered and is corrupt. The target value is stored in the ROM of the scope controller 11.

When it is determined that the checksum of the configuration data does not match the target value, the process moves to Step S109. In Step S109, the spare configuration data set is read from the memory 17. In Step S110, the checksum of the spare configuration data is calculated. In Step S111, it is determined whether the checksum of the spare configuration data matches the target value; namely, whether the spare configuration data set is intact.

If it is determined that the spare configuration data is corrupt, the process goes to Step S112, in which a control signal is transmitted from the scope controller 11 to the system control circuit 31 to display a warning on the monitor 40. The system control circuit 31 controls the image signal processing circuit 32 so as to display character information associated with the warning.

On the other hand, if it is determined at Step S111 that the spare configuration data set is intact, the process moves to Step S113, in which the spare configuration data set is written to the FPGA 13. Thus, the functions of the signal-processing circuit 19 are determined on the basis of the spare configuration data. In Step S114, the spare configuration data set is written over the corrupt main configuration data set in the memory 17, so that the main configuration data set is corrected.

On the other hand, if it is determined at Step S103 that the main configuration data set is intact, the process moves to Step S104, in which the main configuration data is written on the FPGA 13. Thus, the functions of the signal processing circuit 19 are set by the main configuration data.

In Step S105, the spare configuration data set is read from the memory 17 and fed to the configuration data circuit 15. In Step S106, the checksum of the spare configuration data set is calculated. Then, in Step S107, it is determined whether the spare configuration data, which is stored in the memory 17 and unused, is intact. If it is determined that the spare configuration data set is corrupt, the process goes to Step S108, in which the main configuration data set is written over the corrupt spare configuration data. Thus, the spare configuration data set is corrected.

Thus, in the present embodiment, when the video-scope 10 is connected to the video-processor 30, the main configuration data set is read from the memory 17, and it is determined whether the main configuration data set is intact (S101 to S103). IF the main configuration data set is intact, the main configuration data set is written to the FPGA 13 (S104). On the other hand, when the main configuration data set is corrupt, the spare configuration data set is read from the memory 17, and it is determined whether the spare configuration data set is intact (S109 to S111). When the spare configuration data set is intact, the spare configuration data set is written to the FPGA13 (S113). Thus, a normal signal-processing circuit is always created from a back-up configuration data set if the main configuration data set has an error. Consequently, the colors of an image then may be corrected as usual by the intact signal-processing circuit.

Further more, when the main configuration data set is corrupt, it is corrected by the spare configuration data set (S114). Thus, the main configuration data set can be used at the time of the next scope connection. Also, when the main configuration data set is intact, the unused spare configuration data set is checked, and it is corrected if it is found to be defective (S105 to S108). Thus, the back-up or spare configuration data set is always kept in intact condition.

As for the PLD, another logic device, such as a PLA may be used instead of the FPGA13. The signal-processing circuit 19 may be constructed with optional circuits in addition to the initial circuit, amplifier, and the CCD driver. For example, a white-balance processor may be incorporated into the signal processing circuit 19. At least three configuration data sets may be stored in the memory. For example, a plurality of pairs of configuration data sets, each pair a set of two copies of the same data, may be stored in the memory. Also, a plurality of program data sets, each copy of the other, may be stored in a memory.

As for the checking of the configuration data, another process may optionally be carried out in palace of the calculation of the checksum. Considering that the spare configuration data set is assumed intact, the spare configuration data set may be directly written on the FPGA without the data check. A logic device such as an FPGA and memory for storing a configuration data set may be incorporated into the video-processor. The correction of the configuration data set may be carried out at an arbitrary time while the electronic endoscope is in use.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2006-288235 (filed on Oct. 24, 2006), which is expressly incorporated herein, by reference, in its entirety.

1. An electronic endoscope comprising:
a programmable logic device configured to create a signal processing circuit based on a program data set associated with a signal process;
a memory configured to store at least two program data sets, each having the same data content; and
a program setting controller that reads a given program data set from said memory, and that writes the read program data set onto said logic device,
wherein said program setting controller determines whether the read program data set is intact, and writes another program data set, stored in said memory, onto said logic device when the read program data set is not intact.

2. The electronic endoscope of claim 1, wherein said program setting controller further determines whether the another program data set is intact, and writes the another program data set onto said logic device when the another program data set is intact.

3. The electronic endoscope of claim 1, wherein said program setting controller corrects the program data set that is determined to be corrupt, on the basis of an a separate intact program data set stored in said memory.

4. The electronic endoscope of claim 1, wherein said program setting controller further determines whether a given unused program data set in said memory is intact, said program setting controller correcting the unused program data set on the basis of the program data set written in said logic device when the unread program data set is not intact.

5. The electronic endoscope of claim 1, wherein said memory is provided in a video-scope.

6. The electronic endoscope of claim 1, wherein said logic device is provided in a video-scope.

7. The electronic endoscope of claim 1, wherein said program setting controller writes the program data set when a video-scope is connected to a video-processor.

8. An apparatus for creating a signal-processing circuit of an electronic endoscope, comprising:
a determiner that determines whether a program data set in a memory, associated with a signal process, is intact; and
a program setting controller that writes the program data set on a programmable logic device when the program data set is intact, and writes another program data set having the correct original data content, stored in said memory, on said logic device when the read program data set is not intact.

9. A computer-readable medium that stores a program for creating a signal-processing circuit of an electronic endoscope, comprising:
a determination code segment that determines whether a program data set in a memory, associated with a signal process, is intact; and
a program setting control code segment that writes the program data set on a programmable logic device when the program data set is intact, and writes another program data set having the correct original data content, stored in said memory, on said logic device when the read program data set is not intact.

10. A method for creating a signal-processing circuit of an electronic endoscope, comprising:
determining whether a program data set in a memory, associated with a signal process, is intact;
writing the program data set onto a programmable logic device when the program data set is intact; and
writing another program data set having the same data content, stored in said memory, onto said logic device when the read program data set is not intact.
